(19) United States
(12) Patent Application Publication
(10) Pub. No.: US 2006/0038737 A1
(43) Pub. Date: Feb. 23, 2006

(54) Dual component antenna

(76) Inventor: Vasilios Spiropoulos, Valdemars vag (SE)

Correspondence Address: BACHMAN & LAPOINTE, P.C., 900 CHAPEL STREET, SUITE 1201, NEW HAVEN, CT, 06510, US

(21) Appl. No.: 11/255,898

(22) Filed: Oct. 20, 2005

Related U.S. Application Data
(62) Division of application No. 10/483,470, filed on Jan. 12, 2004.
(63) Continuation of application No. PCT/SE02/01117, filed on Jun. 10, 2002.

(30) Foreign Application Priority Data
Jul. 12, 2001 (SE) 0102487-6

(51) Int. Cl. H01P 11/00

(52) U.S. Cl. 343/873; 29/600

(57) ABSTRACT

A method for producing an antenna for a radiocommunications apparatus entails that the antenna is injection molded in a two-shot method. The antenna will then form a continuous piece of at least two different materials. A first material, which is configurationally stable and electrically insulating, and a second material, which is electrically conductive, are employed. An antenna for a radiocommunications apparatus is produced from at least two different materials by injection molding. The first material is configurationally stable and electrically insulating, while the second material is electrically conductive.

### TECHNICAL FIELD

The present invention relates to a method in the production of an antenna for a radiocommunications apparatus.

The present invention further relates to an antenna for a radiocommunications apparatus.

### BACKGROUND ART

Antennas for radiocommunications apparatuses are becoming—like the apparatuses themselves—smaller and smaller. From having previously been designed as telescopic rods, they are now being made steadily smaller and, in certain cases, also integrated inside the radiocommunications apparatus (in daily parlance a cell or mobile telephone). At the same time, the mobile telephones and their components are mass produced, which implies that the manufacture of the antennas should be made as rational as possible.

Hitherto, use has principally been made of various forms of metals for the antennas, for example metal sheeting, metal wire or metal foil. In order to create a contact between the antenna and the electronics of the mobile telephone, use is often made of metal springs for realising a contact by means of a certain contact pressure on a predetermined point, a so-called “pad”. Gold plating of the contact elements and contact surfaces is occasionally used in order to prevent oxidation of the contact elements and contact surfaces. Since gold is a noble metal, no oxide layers are formed on it, but instead a superior conductive capacity may thereby be achieved and maintained. The drawback inherent in gold plating is the costs involved: on the one hand for the raw material and on the other hand for an additional working phase in production.

Another drawback in producing antennas where the radiating element and the contact elements consist of metal sheeting is that this entails considerable limitations in design. The three-dimensional structures which are intended to be produced must be capable of being realised by means of cutting and bending from a two-dimensional workpiece. Thus, not all conceivable forms of antennas can be manufactured in this manner.

One attempted solution to this problem has been made by the employment of platable plastic which, after all, can be moulded or injection moulded in innumerable various geometric configurations. However, the drawbacks inherent in this procedure are that it is still necessary to work in several stages, viz. the moulding of the plastic, pretreatment of its surface and the application of the plating metal. Moreover, the above-outlined corrosion problems remain unsolved unless use is made of gold for realising both the radiating element and the contact elements. Such employment of gold would, however, be quite costly in large scale manufacture.

### Problem Structure

Thus, the present invention has for its object to realise a simple manufacturing method in which the number of working stages such as assembly and plating have been minimised. Moreover, the present invention has for its object to permit a large degree of freedom in design. Finally, the present invention has for its object to realise an antenna displaying superior contact between its contact elements and the remaining electronics of the mobile telephone.

### Solution

The objects forming the basis of the present invention will be attained if the method intimated by way of introduction is characterised in that the antenna is injection moulded in a two step process to form a continuous piece of at least two different materials, and that a first material, which is configurationally stable and electrically insulating, and a second material, which is electrically conductive, are employed.

Regarding the antenna, the objects forming the basis of the present invention will be attained if this is characterised in that it is produced from at least two different materials by injection moulding, a first material being configurationally stable and electrically insulating, and a second material being electrically conductive.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a perspective view of a first embodiment of an antenna according to the present invention;

FIG. 2 is a straight sectional view of an antenna according to FIG. 1;

FIG. 3 is an exploded view of the antenna according to FIGS. 1 and 2;

FIG. 4 is a perspective view of a second embodiment of an antenna according to the present invention; and

FIG. 5 is an exploded view of the antenna according to FIG. 4.

### DESCRIPTION OF PREFERRED EMBODIMENT

The production of an antenna according to the present invention takes place as follows: the antenna is injection moulded with the aid of an injection moulding tool. The tool must be manufactured separately for each antenna model, but may then be employed for a large number of antennas in mass production. In the injection moulding operation, two different materials are employed. The first material is configurationally stable and electrically insulating. Typically, this is some type of plastic. The second material which is used is electrically conductive, but is nevertheless elastic to a considerably higher degree than most metals. The second material is, like the first, suitable for injection moulding. The two materials are, granted, unlike one another but they should nevertheless be harmonious to such a degree that they can be injection moulded in the same tool without difficulty. For example, the temperature ranges in the injection moulding should substantially agree with one another so that the first material does not melt or is not deformed when the second material is injected into the tool.

The injection moulding takes place in two so-called “shots”. This implies that first the one substance, preferably for the carrier, is injected into the tool, whereafter the second material is injected into the tool and fills out the remaining cavities. Thereafter, the tool is opened and a finished antenna is removed. No further processing is necessary, but the antenna is instead ready to be placed in the mobile telephone.

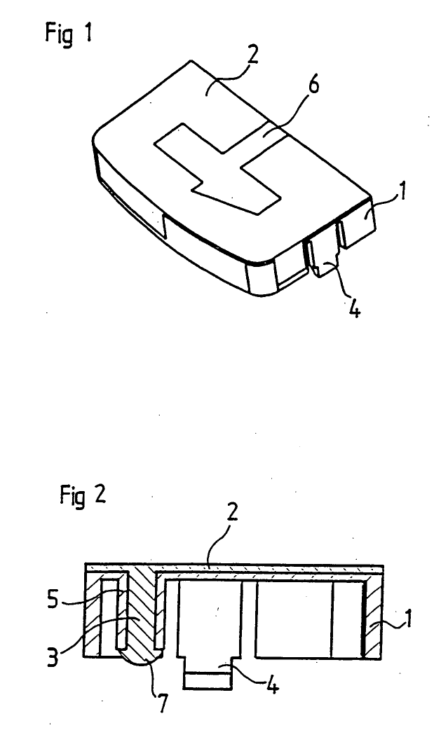

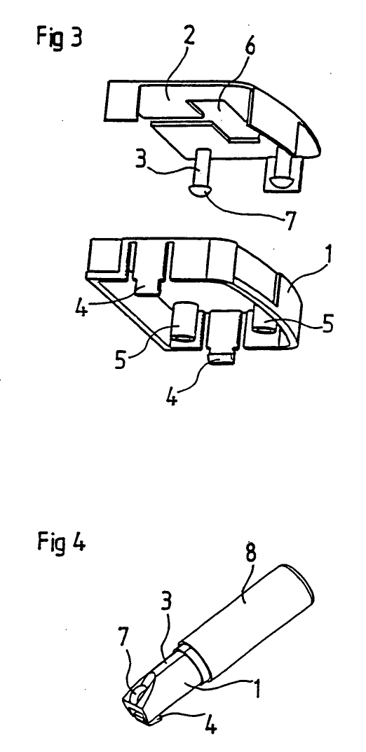

FIG. 1 shows an antenna according to the present invention. The antenna is substantially constructed from a carrier 1, a radiating element 2 and contact elements 3 which are two in number in the preferred embodiment. The contact elements 3 are concealed in FIG. 1 but are clearly visible in FIGS. 2 and 3.

The carrier 1 is constructed from a configurationally stable and non-conductive material, such as a plastic. The radiating element 2 and the contact elements 3 consist, in the preferred embodiment, of the same material, namely a flexible and conductive material, preferably a silicon material.

As was mentioned earlier, the carrier I is configurationally stable, which implies that it is capable of supporting the radiating element 2 and imparting rigidity to it, even thought the latter consists of a very soft and flexible material which will not keep its shape without assistance. Moreover, the carrier 1 creates a spacing between the radiating element 2 and a substrate which may typically be a circuit card. In the preferred embodiment, the carrier 1 is of box-like configuration, where the radiating element 2 is disposed substantially on the upper side of the box. It is thereby possible to place other components on the circuit card “inside” the box, i.e. beneath the radiating element. One precondition is naturally that this procedure is otherwise appropriate.

In order to fix the carrier 1 in relation to the substrate, generally a circuit card, the carrier 1 is provided with at least one and, in the preferred embodiment, two elements for snap catching at the substrate. The elements 4 for snap catching are manufactured from the same material as the rest of the carrier 1 and are of such geometric configuration that they are slightly resilient Typically, the carrier 1 is mounted with the aid of the snap catches 4 in recesses provided for this purpose in the circuit card. The catching at the substrate is simple and is put into effect by light pressure. Thus, no soldering or gluing is required for mounting the antenna.

In FIG. 3, which is an exploded view of the antenna, a pair of supports 5 for the contact elements 3 are particularly clearly visible. In the preferred embodiment, the supports 5 are in the form of tubes of substantially the same length as the contact elements 3.

The radiating element 2 is flexible and may very well display a rubber-like structure. The radiating element 2 is moreover conductive, which, in the preferred embodiment, entails that it is manufactured from a conductive silicon material. The silicon material has been rendered conductive by the admixture of a sufficiently large quantity of conductive particles. Despite this admixture, the structure of the silicon is substantially maintained. The radiating element 2 may be given a number of various designs, and the design in the preferred embodiment is to be considered only as one example of such design. In this embodiment, the radiating element 2 has been provided with an aperture 6. The aperture 6 may have the illustrated configuration, but a large series of other configurations is also conceivable. The illustrated embodiment is one example of a so-called “dual band” antenna, but other antenna types may also be manufactured using the manufacturing method according to the present invention. The radiating element may also be given completely different types of designs, for example in meandering configuration. In the preferred embodiment, the radiating element 2 is principally disposed above the carrier 1. Certain parts of the radiating element 2 extend however a distance down along the sides of the carrier 1. However, the illustrated example should not be seen as a restriction. Thus, the radiating element 2 can be disposed alternatively on the underside of the carrier 1.

The radiating element 2 is united electrically with the substrate, typically the circuit card, via the contact elements 3 which, in the preferred embodiment, are two in number. The contact elements 3 are of one piece manufacture with the radiating element and of the same material as it. The contact elements 3 extend a distance away from the radiating element 2 and have, in the preferred embodiment, a rounded termination in the end regions 7 of the contact elements 3. The form of the end region 7 is highly variable, but it should be adapted for contact with a contact surface on the circuit card, a so-called “pad”. The end regions 7 of the contact elements 3 are pressed against the contact surface when the antenna is mounted and are snapped in place with the aid of the snap catches 4. In such instance, the end regions 7 will be flattened out somewhat, but the material is of such a nature that, to some extent, it strives to reassume its original form. Thus, contact forces will be created in the interface between the contact surface and the end regions 7 of the contact elements 3. In this instance, a good contact is established and air is denied access to the contact point, for which reason oxidation of the contact surface and the contact elements 3 is prevented. Thus, plating of the contact elements 3 or the contact surface is unnecessary.

As shown in FIGS. 2 and 3, the contact elements 3 are elongate and, since the material included is not configurationally stable, it is advantageous that the contact elements are supported by the support members 5 on the carrier 1.

### DESCRIPTION OF ALTERNATIVE EMBODIMENTS

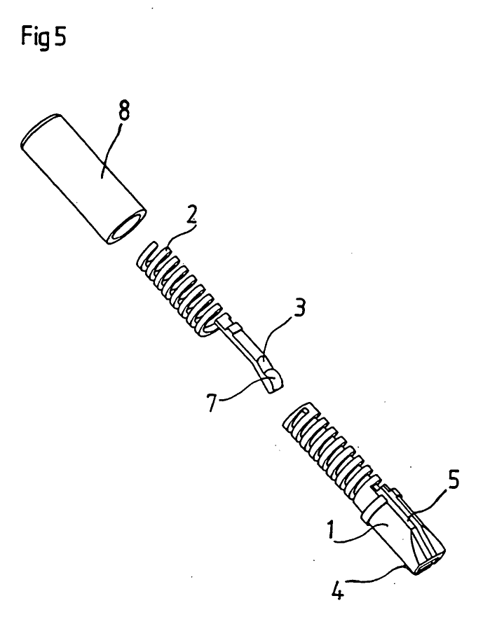

FIGS. 4 and 5 show an alternative embodiment of an antenna according to the present invention. FIG. 4 shows the whole of the antenna in perspective. The antenna is a so-called “stub antenna” and is intended to project out a short distance from the mobile telephone in which it is mounted. Because of its exposed position, the antenna has a casing 8 in which the antenna is enclosed. The carrier 1 is, as was described above, manufactured from a configurationally stable and insulating material, but its form is more complex than the carrier according to the preferred embodiment. This complexity is because of the fact that the radiating element 2 is in the form of a helix. Thus, the carrier 1 is designed to support and carry the helix. In this embodiment, there is only one contact element 3, with an end region 7 which is substantially of the same properties as those described for the preferred embodiment Also in this embodiment, there is a snap catch 4 for mechanical retention of the antenna It should be observed that an antenna of this form is difficult to manufacture from metal sheeting. Certainly, such an antenna could be manufactured from metal wire, but the above-mentioned problems with plating of the contact element nevertheless remain. Moreover, manufacture is simplified compared with metal wire antennas when the intention is to produce helical antennas of complicated structures, e.g. a varying pitch in the helix

In the foregoing, it was disclosed that the antenna is mounted by snap catching. While this method is to be preferred, other assembly methods are naturally possible, such as screwing and soldering.

The support members 5 may be adapted for supporting contact elements 3 of a different design, for example linear contact In such instance, the supports 5 are made wider in order to support the contact elements throughout all of or the greater part of their width.

Another alternative embodiment, which is not shown on the Drawings, is realised if the casing of the mobile telephone proper is used as the carrier 1. The casing of the mobile telephone is generally manufactured from such a material as has those properties that are required of the carrier 1. Thus, the radiating element 2 is applied in a dual component injection moulding process already on the manufacture of the casing. Preferably, the inside of the casing is used for carrying the radiating element 2, not least to protect it from wear. The inside of the casing may be modified so that, for example, the support members 5 for the contact elements 3 are created at the manufacturing stage. In this instance, the support members 5 are advantageously designed as pins around which the contact elements 3 are subsequently disposed. Correspondingly to that described above, the support members 5 may be widened for adaptation to the contact elements 3 with linear abutment against the circuit card. As a result of this method, further space is saved in the mobile telephone and on its circuit card and unnecessary working phases in manufacture are eliminated.

While injection moulding of the antenna affords particular advantages in manufacture, it is also possible to squirt the silicon out on the carrier. Other conceivable manufacturing methods are extrusion and manufacture employing retrofitting.

Other manufacturing materials than electrically conductive silicon are, as was intimated above, possible. The essential feature is that the material is both electrically conductive and soft so that both a radiating element 2 and formable contact elements 3 can be manufactured in one piece from the material. Another example of manufacturing materials is a soft plastic which has been rendered electrically conductive. Yet a further variation is that the material for manufacture of the configurationally stable carrier is also non-magnetic in addition to being configurationally stable and electrically insulating.

The present invention may be modified without departing from the scope of the appended Claims.

1-3. (canceled)

4. An antenna for a radioacommunications apparatus, characterised in that the antenna is produced from at least two different materials by injection moulding, a first material being configurationally stable and electrically insulating, and a second material being electrically conductive.

5. The antenna as claimed in claim 4, characterised in that the antenna includes a radiating element (2) which is manufactured from the second, electrically conductive material.

6. The antenna as claimed in claim 5, characterised in that the second material is elastic.

7. The antenna as claimed in claim 6, characterised in that the antenna includes a contact element (3) which is manufactured from the second material.

8. The antenna as claimed in claim 7, characterised in that the radiating element (2) and the contact element (3) are of one piece manufacture with each other.

9. The antenna as claimed in any of claims 4 to 8, characterised in that the first, configurationally stable material functions as a carrier (1) for the second material.

10. The antenna as claimed in claim 9, characterised in that the second material is a silicon material.

11. The antenna as claimed in claim 9, characterised in that the carrier (1) includes anchorage means for mounting in the radiocommunications apparatus.
